(19) United States
(12) Patent Application Publication
(10) Pub. No.: US 2025/0050452 A1
(43) Pub. Date: Feb. 13, 2025

(54) LASER SCORING OF POLYMERIC SUBSTRATES FOR USE IN PACKAGING

(71) Applicant: C.P. Converters, Inc., York, PA (US)

(72) Inventor: Daniel R. COLLINS, II, Victor, NY (US)

(21) Appl. No.: 18/799,139

(22) Filed: Aug. 9, 2024

Related U.S. Application Data
(60) Provisional application No. 63/518,613, filed on Aug. 10, 2023.

(51) Int. Cl. B23K 26/359; B23K 103/00; B65D 27/34

(52) U.S. Cl. CPC B23K 26/359; B65D 27/34; B23K 2103/42

(57) ABSTRACT

A method for laser scoring a polymeric substrate for packaging. The method includes providing a polymeric substrate and a laser apparatus. The laser apparatus includes a laser arranged and disposed to provide laser energy to a surface of the polymeric substrate. The laser apparatus is configured with a control sequence having a power setting and a frequency setting to deliver the laser energy. The laser energy is directed from the laser apparatus according to the control sequence at a power corresponding to the power setting and a frequency corresponding to the frequency setting to the polymeric substrate to form a score channel into the surface. The laser energy ablates the polymeric substrate to form the score channel. A laser scoring system and an easy-open package utilizing score channels formed by laser ablation are also disclosed.

### CROSS REFERENCE TO RELATED APPLICATIONS

This application is a non-provisional patent application claiming priority and benefit of U.S. Provisional Patent Application No. 63/518,613, filed Aug. 10, 2023, entitled “LASER PERFORATION OF ALL POLYETHYLENE RECYCLABLE STRUCTURES FOR EASY OPENING”, which is hereby incorporated by reference in its entirety.

### FIELD OF THE INVENTION

The present disclosure is generally directed to a method of laser scoring for polymeric substrates for use in packaging.

### BACKGROUND OF THE INVENTION

Products such as food and personal care items are provided in packages that provide for access. The packages protect the product from damage during shipping and handling; seal the product to prevent the product from deterioration due to environmental conditions for predetermined periods of time and as a storage vessel. Once opened, while most containers can be reclosed, the effectiveness of the closing arrangement varies widely.

A typical film bag for storage of food or personal care items is made from a laminate of polyester with is laminated to a polyethylene layer that includes an outer film layer adhesively secured to an inner sealing layer. The outer layer is usually made from a material that facilitates printing. The inner layer is usually made from a material that enables the package to be sealed. Once sealed, the bag typically has a perforation or other structure that allows easy opening of the bag to access the food or personal care items. There are several sustainability goals to make all structures a material construction that can be recycled. However, the formation of perforations according to known methods may result in poor perforations or undesirable melting and/or solidification of polymer material in areas that impede tearing and/or opening of storage structures. For example, known laser processes either lack the ability to score or perforate these materials, or melt the polyethylene creating a structure that is difficult to tear without damaging the packaging material.

What is needed is a method and system for forming scoring in food or personal care item storage structures that doesn't suffer from the drawbacks of the prior art. Other features and advantages will be made apparent from the present specification. The teachings disclosed extend to those embodiments that fall within the scope of the claims, regardless of whether they accomplish one or more of the aforementioned needs.

### SUMMARY OF THE INVENTION

The present disclosure includes a method, apparatus and product for laser scoring polymeric substrates, such as a polyethylene recyclable structures to provide easy-open packaging. Examples of easy-open packaging include recyclable packaging for food or personal care items.

One embodiment of the present disclosure is directed to a method for laser scoring a polymeric substrate for packaging. The method includes providing a polymeric substrate and a laser apparatus. The laser apparatus includes a laser arranged and disposed to provide laser energy to a surface of the polymeric substrate. The laser apparatus is configured with a control sequence having a power setting and a frequency setting to deliver the laser energy. The laser energy is directed from the laser apparatus according to the control sequence at a power corresponding to the power setting and a frequency corresponding to the frequency setting to the polymeric substrate to form a score channel into the surface. The laser energy ablates the polymeric substrate to form the score channel.

Another embodiment of the present disclosure includes a laser scoring system for packaging material. The system includes a laser apparatus having a laser arranged and disposed to provide laser energy to a surface of the polymeric substrate. The laser apparatus includes a controller configured with a control sequence having a power setting and a frequency setting. The control sequence produces laser energy from the laser at a power corresponding to the power setting and a frequency corresponding to the frequency setting that interacts with the substrate to ablate a portion of the surface of the polymeric substrate to form a score channel.

Another embodiment of the present disclosure includes an easy-open package. The easy-open package includes a package body formed from a polymeric web. The polymeric web includes a score pattern of score channels formed by laser ablation.

Other features and advantages of the present invention will be apparent from the following more detailed description of the preferred embodiment, taken in conjunction with the accompanying drawings which illustrate, by way of example, the principles of the invention.

### BRIEF DESCRIPTION OF DRAWINGS

FIG. 1 shows a polymeric substrate having a score channel formed by a laser having a configuration outside the settings of embodiments according to the present disclosure.

FIG. 2 shows a polymeric substrate having a score channel formed according to a method according to the present disclosure.

FIG. 3 shows a package body having a score pattern of score channels formed according to a method according to the present disclosure that is shown to be torn along the score pattern.

FIG. 4 shows a laser scoring system for forming score channels in polymeric webs according to an embodiment of the present disclosure.

Wherever possible, the same reference numbers will be used throughout the drawings to represent the same parts.

### DETAILED DESCRIPTION OF THE INVENTION

A process for laser perforation on polyethylene recyclable structures, such as storage bags for food or personal care items for easy opening. Advantages of this process according to the present disclosure include the ability to form scoring in packaging that provides easy manual opening by tearing, wherein the packaging opens reproducibly without undue damage or stretching to the packaging material. The score channels formed by the process according to the present disclosure are formed by ablation, wherein little or no melting of the packaging takes place, allowing for clean tearing along a score pattern. In addition, the process and product according to the present disclosure provides consumer convenience, ease of handling (e.g., does not require consumers to use a knife or scissors), creates a consistent and predictable opening failure that does not require the contents to be repackaged if the bag is improperly torn.

The method according to the present disclosure includes variation to the laser frequency and power. Laser energy from a laser is directed to the areas of storage structure to heat and perforate the areas having the ink and/or adhesive. This method allows the polymeric structures to be ablated by proper absorption of the laser energy. The method and system according to the present disclosure is particularly suitable for polyethylene containing polymeric substrates. Other polymers suitable for use with the method of the present disclosure includes, but is not limited to, low-density polyethylene (LDPE), high-density polyethylene (HDPE), medium-density polyethylene (MDPE), ethylene vinyl alcohol, (EVOH), ethylene-vinyl acetate (EVA), polypropylene (PP), terephthalate (PET) and synthetic amide-polymers, such as nylon.

In embodiments according to the present disclosure, the laser scoring for easy tearing along the score, for example for opening of packaging bodies, is prepared with variation of the laser frequency and power. The frequency is configured to allow the energy to be delivered in a manner that will ablate the polyethylene rather than melt polyethylene. The power is adjusted to a point that can control depth and not melt the polyethylene. The printing of colors via dyes or inks and/or adhesive may be used to create the structure aid in the absorption of the laser energy. However, the process according to the present disclosure does not require the presence of inks, dyes, adhesives or other additives to allow controlled ablation to form the score channels according to the present disclosure.

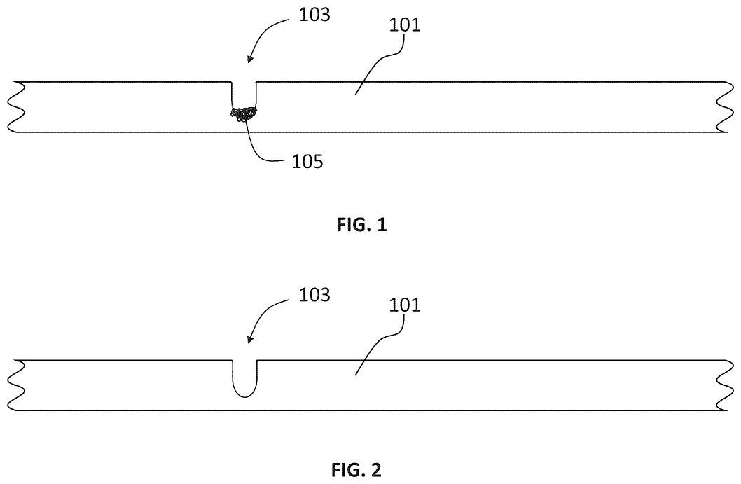

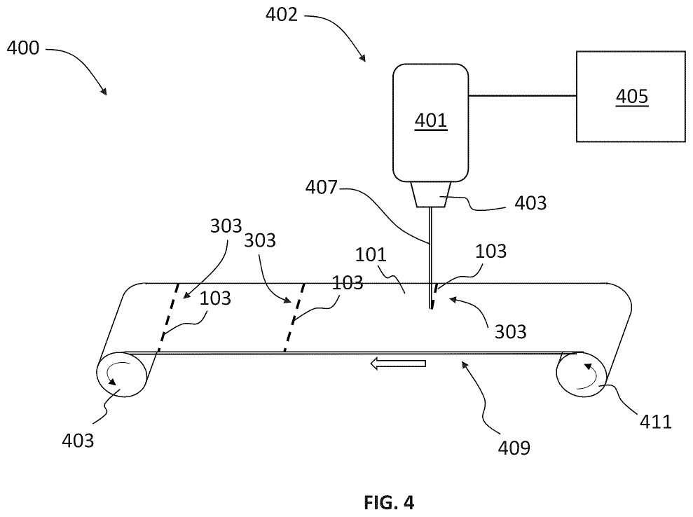

FIG. 1 shows a polymeric substrate 101 having a score channel 103 according to a laser according to a prior art laser configuration. As shown in FIG. 1, the score channel 103 includes a melted polymer 105. The melted polymer 105 provides a barrier to tearing and results in damage to the substrate 101 when torn along the score channel 103. FIG. 2 shows a polymeric substrate 101 having a score channel 103 formed according to a method according to the present disclosure. In the embodiment shown in FIG. 2, the score channel 103 has been ablated and the material of the substrate 101 has been removed without melting or leaving undesirable polymeric structures behind. In one embodiment, the score channel 103 is devoid of melted polymer. As utilized herein, ablate, ablation, ablated and other grammatical variations therefore, is utilized to mean a process or the result of a process that destroys, evaporates, disintegrates or otherwise removes a material resulting in little or no melting or burning/charring of the substrate 101. The desired removal of material of the substrate 101 is typically accomplished in a manner that results in a geometric shape. For example, the score channel 103 may have a cross-sectional geometry including, but not limited to a square, rectangle, triangle, oval, semi-rectangular, semi-oval and rounded geometries thereof. Laser scoring, as utilized herein, is a process of forming cuts, grooves, channels indentations, or similar structures extending partially across the thickness of a substrate 101, wherein these structures are formed utilizing laser energy 407. For example, score channels 103 may be formed with the utilization of a laser 401 which provides regulated laser energy 407 (see for example, FIG. 4) that is absorbed by the substrate 101 in order to create a desired removal of material from the substrate 101. The regulated laser energy 407 will disintegrate or otherwise remove the media or polymer without melting or burning of the material of the substrate 101.

Substrate 101 may include any suitable polymeric material, including, for example, but not limited to, polyethylene (e.g., high-density polyethylene, medium-density polyethylene, low-density polyethylene and linear low-density polyethylene). Other polymers suitable for use with the method of the present disclosure includes, but is not limited to, low-density polyethylene (LDPE), high-density polyethylene (HDPE), medium-density polyethylene (MDPE), ethylene vinyl alcohol, (EVOH), ethylene-vinyl acetate (EVA), polypropylene (PP), terephthalate (PET) and synthetic amide-polymers, such as nylon. In another embodiment, substrate 101 may, for example, be polyethylene containing packaging, wherein the substrate 101 may be a single or multiple web that may be combined together through a lamination process. The layers may include materials other than polyethylene. The lamination process may include, for example, up to 10% by thickness, inks, dyes and/or adhesives which may be incorporated within the multiple layers and may act as contaminates during the laser ablation. These contaminates may change the absorptive interaction of the laser energy 407 and the substrate 101, but the configuration of the laser apparatus 402 according to certain embodiments of the present disclosure permit ablation and scoring even with the presence of contaminates up to about 10% by thickness.

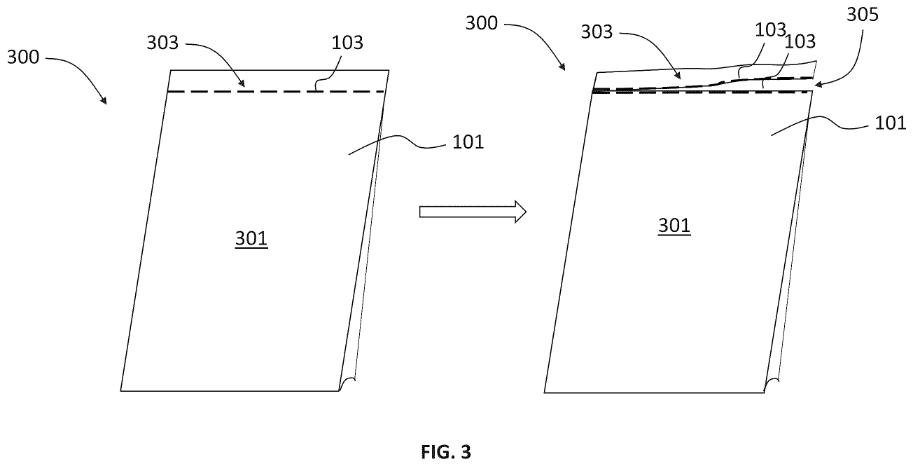

FIG. 3 shows a package body 301 having a score pattern 303 of score channels 103 formed according to a method according to the present disclosure. As shown in FIG. 3, the package body 301 may be torn to provide an easy opening (as shown on the right) along the score pattern 303 to form a tear opening 305. The tear opening 305 preferably includes substantially clean or straight edges that do not substantially deviate from the score pattern 303. A good tear is defined, herein, as a predictable tear (propagate along a pattern), with consistent resistance or strength.

FIG. 4 shows a laser scoring system 400 for forming score channels 103 in a substrate 101 in the form of a polymeric web 409 suspended between rollers 411 according to an embodiment of the present disclosure. As shown in FIG. 4, the laser scoring system 400 includes a laser apparatus 402 including a laser 401, a lens 403 and controller 405. The laser 401 is a device that provides a direct beam of laser (Light Amplification by Stimulated Emission of Radiation) energy that is controlled and amplified through lens 403. Lens 403 may be a single or a series of lenses that provide changes to power intensity and pulse frequency of the laser energy 407. The laser 401 also has a field of view (FOV) and fixed distance that is controlled to the substrate 101 or polymeric web 409. Laser 401 may be any suitable laser that is capable of providing the power and frequency according to embodiments of the present disclosure to ablate the score channels 103 into the substrate 101. For example, laser 401 may be a CO₂ laser, a YAG laser, a UV laser or other similar laser. A particularly suitable type of laser is a CO₂ laser. Although the arrangement of polymeric web 409 in FIG. 4 is shown as a suspension between rollers, other arrangements of polymeric web 409 may be utilized. In a particularly suitable embodiment, the polymer web 409 is suspended at the point of impingement of the laser energy 407. By suspension, as utilized herein, it is meant that at the point of impingement of the laser energy 407, there is no material or structure in contact with the polymer web 409.

The laser 401 is arranged and disposed to provide laser energy 407, which may be a beam, ray or similar form of laser energy generated by laser 401 and controlled and amplified through lens 403. The controller 405 provides control to the laser 401 is able to configure the laser and provide a laser energy 407 corresponding to a control sequence. The control sequence, as utilized herein, is the configuration of the apparatus, including the controlled elements of the apparatus and process according to the present disclosure. For example, the control sequence may include a power setting and/or a frequency setting for laser 401 that provides a power and frequency that correspond to the power and frequency settings. Controller 405 may be any suitable controller 405 that is usable with the laser apparatus 402 and the laser scoring system 400. For example, the controller 405 may include one or more computer-based controllers (e.g., a programmable logic controller) configured to operate the components of laser scoring system 400 using, for example, one or more process control loops, including the control sequence and configuration and operation of laser 401. In other embodiments, controller 405 may include any known computer-based controllers known for operating laser 401 while being able to configure the laser 401 according to embodiments of the present disclosure.

There are several variables that are controlled on the laser 401 in order to create the laser ablation according to the present disclosure. One variable is power. Suitable lasers 401 for use with the method according to the present disclosure may have capabilities of varying power from 40 to 250 kilowatts. However, lasers 401 operating of kilowatt output above 120 kilowatts is extremely atypical and cannot be controlled in ablation of many polymers. In order to make an effective score channel 103 in polyethylene, according to an embodiment of the present disclosure, the energy output is set at a range of 120 to 250 kilowatts.

Another variable is that of frequency. Frequency of laser 401 is communicated as PRR (Pulse Repetition Rate) in a measurement of Hertz (Hz). The frequency of the laser 401 is typically a fixed variable that emits the laser energy 407 within a pulse that is measured within Hz and corresponds to that of cycles of pulse per second. Suitable lasers 401 for use with the method according to the present disclosure may have capabilities of varying frequency from 10 Hz to 250 KHz. The standard of fixed variable pulse is that of 100 HZ. In order to make an ablation in polyethylene, according to an embodiment of the present disclosure, the frequency is raised to a range of 150 to 300 Hz for effective energy absorption to result in ablation.

Another variable is the dwell of the laser energy 407 in combination of the material of the substrate 101. This is controlled by the moment of the substrate 101 as the laser 401 is in a fixed position and the material or polymer is a polymeric web 409 that can be controlled by speed. Dwell, as utilized herein, is a measured line speed or substrate velocity, in which the substrate surface is exposed to the laser energy 407. Examples of lines speed in which the system may be run includes line speed of from 50 to 12000 feet per minute. Suitable line speeds or substrate velocity include, for example, 200 to 400 feet per minute at the power and frequency according to the present disclosure. The combination of the power, frequency and dwell may ablate the substrate 101 and provide desirable score channels 103 in materials such as polyethylene.

Another component to be controlled within the process according to the present disclosure is that of heat generated within the process. Many polymers readily absorb the laser energy 407 and can easily be ablated. This is true of polypropylene and polyester. The typical way to make an ablation on packaging is to focus the laser energy on the web in an area over a roller. This provides support to web or polymer for stability during ablation. The polyethylene polymer conducts the residual energy to any supporting roller. Due to this energy conduction if is necessary to ablate polyethylene in an area that is suspended or unsupported by a roller 411 or any other material.

The configuration in which the score pattern 303 is formed is able to be formed by controlling laser 401. For example, to create a broken line patter, the laser 401 may be controlled to selectively fire the laser energy 407 to provide the desired pattern.

### EXAMPLE

TABLE 1

| | | | | | L1-3 | L1-3 Ref | L4 | L4 Ref | |
|---|---|---|---|---|---|---|---|---|---|
| | Film | | | Speed | Pwr | Spd | Pwr | Spd | |
| EX | Material | Lam | Sealant Film | fpm | % | mpm | % | mpm | Tear Perf |
| 1 | 100 OPP | Adh | 2.5 mil Wht | 1300 | 39 | 600 | 63 | 600 | Excellent |
| | | | HDPE | | | | | | |
| 2 | 48 PET | Adh | 2.5 mil Wht | 1300 | 39 | 600 | 63 | 600 | Excellent |
| | | | HDPE | | | | | | |
| 3 | 70 OPP | 7 Wht | 70 Met OPP | 1300 | 39 | 600 | 63 | 600 | Excellent |
| | | PE | | | | | | | |
| 4 | 90 HDPE | Adh | 2 mil Wht | 380 | 70 | 125 | 100 | 125 | Excellent |
| | | | HDPE | | | | | | |
| 5 | 2 mil PE- | | | 300 | 70 | 125 | 100 | 100 | V Good |
| | EVOH | | | | | | | | |

Examples 1-5 were run at varying powers and speeds on various materials. The results of the Examples 1-5 are shown in Table 1. The Examples were performed on a demanding structure or machine direction-oriented HDPE (MOHDPE) printed and laminated to a LDPE/HDPE/LLDPE secondary web. The results for these examples show that the tear perforation (e.g., “good tear”) for Examples 1-5 were either excellent or very good.

While the exemplary embodiments illustrated in the figures and described herein are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re-sequenced according to alternative embodiments.

It is important to note that the construction and arrangement of the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present application.

1. A method for laser scoring a polymeric substrate for packaging, the method comprising:
providing a polymeric substrate;
providing a laser apparatus having a laser arranged and disposed to provide laser energy to a surface of the polymeric substrate;
configuring the laser apparatus with a control sequence having a power setting and a frequency setting to deliver the laser energy;
directing the laser energy from the laser apparatus according to the control sequence at a power corresponding to the power setting and a frequency corresponding to the frequency setting to the polymeric substrate to form a score channel into the surface;
wherein the laser energy ablates the polymeric substrate to form the score channel.

2. The method of claim 1, wherein the polymeric substrate comprises polyethylene.

3. The method of claim 1, wherein the power from about 120 to about 250 kilowatts.

4. The method of claim 1, wherein the frequency is from about 150 Hz to about 300 Hz.

5. The method of claim 1, wherein the polymeric substrate is a polymeric web.

6. The method of claim 5, wherein the polymeric web is unsupported at the location where the laser interacts with the polymeric substrate.

7. The method of claim 5, wherein the polymeric web is advanced along a path substantially perpendicular to the directing of the laser energy.

8. The method of claim 7, wherein the control sequence further includes a dwell setting wherein the speed of the advancing of the polymeric web is from about 200 to about 400 feet per minute.

9. The method of claim 1, wherein the score channels are devoid of melted polymer.

10. A laser scoring system for packaging material comprising:
a laser apparatus having a laser arranged and disposed to provide laser energy to a surface of the polymeric substrate, the laser apparatus having a controller configured with a control sequence having a power setting and a frequency setting;
wherein the control sequence produces laser energy from the laser at a power corresponding to the power setting and a frequency corresponding to the frequency setting that interacts with the substrate to ablate a portion of the surface of the polymeric web to form a score channel.

11. The system of claim 10, wherein the polymeric substrate comprises polyethylene.

12. The system of claim 10, wherein the power is from about 120 to about 250 kilowatts.

13. The system of claim 10, wherein the frequency is from about 150 Hz to about 300 Hz.

14. The system of claim 10, wherein the polymeric substrate is a polymeric web.

15. The system of claim 14, wherein the polymeric web is unsupported at the location where the laser interacts with the polymeric substrate.

16. The system of claim 14, wherein the polymeric web is advanced along a path substantially perpendicular to the directing of the laser energy.

17. The system of claim 16, wherein the control sequence further includes a dwell setting wherein the speed of the advancing of the polymeric web is from about 200 to about 400 feet per minute.

18. An easy-open package comprising:
a package body formed from a polymeric web, the polymeric web having a score pattern of score channels formed by laser ablation.

19. The package of claim 18, wherein the polymeric web comprises polyethylene.

20. The package of claim 18, wherein the score channels are devoid of melted polymer.
